(19) United States
(12) Patent Application Publication
(10) Pub. No.: US 2012/0105292 A1
(43) Pub. Date: May 3, 2012

(54) Communication Device and Antenna Thereof

(75) Inventors: Kin-Lu Wong, Hsichih (TW); Yu-Wei Chang, Hsichih (TW)

(73) Assignee: ACER INCORPORATED, Hsichih (TW)

(21) Appl. No.: 13/088,574

(22) Filed: Apr. 18, 2011

(30) Foreign Application Priority Data
Oct. 27, 2010 (TW) 99136670

(51) Int. Cl. H01Q 1/36; H01Q 5/01

(52) U.S. Cl. 343/749; 343/843

(57) ABSTRACT

A communication device is provided, including a ground element, a substrate and an antenna. The substrate is adjacent to the ground element. The antenna provides a first band and a second band, and the antenna is disposed on the substrate. The antenna includes a radiator, a feed conductor, a capacitor unit and a short-circuiting unit. An end of the feed conductor is connected to a signal source, and another end of the feed conductor is electrically connected to the radiator. The capacitor unit is disposed on the feed conductor. The short-circuiting unit includes a first short-circuiting path and a second short-circuiting path, wherein the first and a second short-circuiting paths electrically connect the radiator to the ground element, the first short-circuiting path has a first path length, the second short-circuiting path has a second path length, and the first and second path lengths are longer than 0.05 times that of a wavelength of a lowest frequency of the first band.

### CROSS REFERENCE TO RELATED APPLICATIONS

This Application claims priority of Taiwan Patent Application No. 099136670, filed on Oct. 27, 2010, the entirety of which is incorporated by reference herein.

### BACKGROUND OF THE INVENTION

1. Field of the Invention

The present invention relates to a communication device and an antenna thereof, and in particular, relates to a communication device with a built-in antenna providing two wide operation bands.

2. Description of the Related Art

Based on requirements of high speed wireless communications, Long Term Evolution (LTE) has been disclosed. Nowadays, it is desired that small wideband antennas satisfy the LTE/GSM/UMTS standards. However, conventional antennas, such as an antenna disclosed in TAIWAN patent No. 1308,408, cannot satisfy the LTE/GSM/UMTS standards, simultaneously. In TAIWAN patent No. 1308,408, the antenna utilizes two resonant paths to realize dual-band operations. However, the two-resonant path design provides narrow bandwidths with large dimensions, and cannot satisfy the LTE/GSM/UMTS (eight bands) standards, simultaneously.

### BRIEF SUMMARY OF THE INVENTION

The invention provides a communication device including a built-in antenna. The antenna includes a radiator, a feed conductor, a capacitor unit and a short-circuiting unit. The capacitor unit is disposed on the feed conductor. The short-circuiting unit includes a first short-circuiting path and a second short-circuiting path to control impedance matching, to increase bandwidths, and to reduce dimensions of the antenna. The operation band of the antenna covers the LTE700/GSM850/900 (704˜960 MHz) and GSM1800/1900/UMTS/LTE2300/2500 (171˜2690 MHz) bands. Therefore, the antenna of the embodiment of the invention satisfies LTE/GSM/UMTS (eight bands) transmission requirements, and can be utilized in slim portable communication devices.

In one embodiment, a communication device is provided, including a ground element, a substrate and an antenna. The substrate is adjacent to the ground element. The antenna provides a first band and a second band, and the antenna is disposed on the substrate. The antenna includes a radiator, a feed conductor, a capacitor unit and a short-circuiting unit. An end of the feed conductor is connected to a signal source, and another end of the feed conductor is electrically connected to the radiator. The capacitor unit is disposed on the feed conductor. The short-circuiting unit includes a first short-circuiting path and a second short-circuiting path, wherein the first and a second short-circuiting paths electrically connect the radiator to the ground element. The first short-circuiting path has a first path length, and the second short-circuiting path has a second path length. The first and second path lengths are longer than 0.05 times that of a wavelength of a lowest frequency of the first band.

The invention utilizes the capacitor unit, the first short-circuiting path and the second short-circuiting path to improve impedance bandwidths of the first band and a second band. The capacitor unit decreases the high inductance of the input impedance generated by the direct-feed design of the antenna to improve impedance matching of the first band. The first short-circuiting path and the second short-circuiting path further improve impedance matching to increase operation bandwidths of the antenna. The first and second short-circuiting path lengths are longer than 0.05 times that of a wavelength of a lowest frequency of the first band to improve impedance matching of the first band, and to generate a new resonant mode at the second band, and to increase bandwidth of the first band and the second band. The first band covers the LTE700/GSM850/900 (704˜960 MHz) standards. The second band covers the GSM1800/1900/UMTS/LTE2300/2500 (171˜2690 MHz) standards. Therefore, the antenna of the embodiment of the invention satisfies the LTE/GSM/UMTS (eight bands) transmission requirements.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a communication device of a first embodiment of the invention;

FIG. 2 shows simulated return loss of the antenna of the first embodiment;

FIG. 3 shows a communication device of a second embodiment of the invention;

FIG. 4 shows a communication device of a third embodiment of the invention;

FIG. 5 shows a communication device of a fourth embodiment of the invention;

FIG. 6 shows a communication device of a fifth embodiment of the invention; and

FIG. 7 shows a communication device of a sixth embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

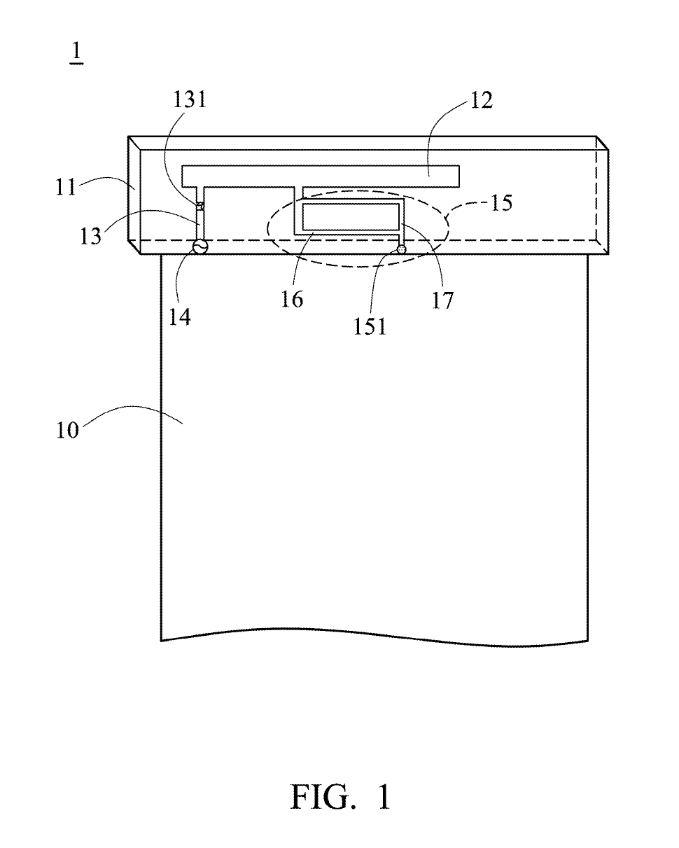

FIG. 1 shows a communication device 1 of a first embodiment of the invention, which comprises a ground element 10 and an antenna. The antenna provides a first band and a second band, and the antenna is disposed on a substrate 11 adjacent to the ground element 10. The antenna comprises a radiator 12, a feed conductor 13, a capacitor unit 131 and a short-circuiting unit 15. An end of the feed conductor 13 is connected to a signal source 14, and the other end of the feed conductor 13 is electrically connected to the radiator 12. The capacitor unit 131 is disposed on the feed conductor 13. The short-circuiting unit 15 comprises a first short-circuiting path (first short-circuiting portion) 16 and a second short-circuiting path (second short-circuiting portion) 17, wherein the first short-circuiting path 16 and the second short-circuiting path 17, electrically connect the radiator 12 to the ground element 10 (at ground point 151). The first short-circuiting portion 16 is substantially L-shaped, and the second short-circuiting portion 17 is substantially L-shaped. The first short-circuiting portion 16 and the second short-circuiting portion 17 define a rectangular slot.

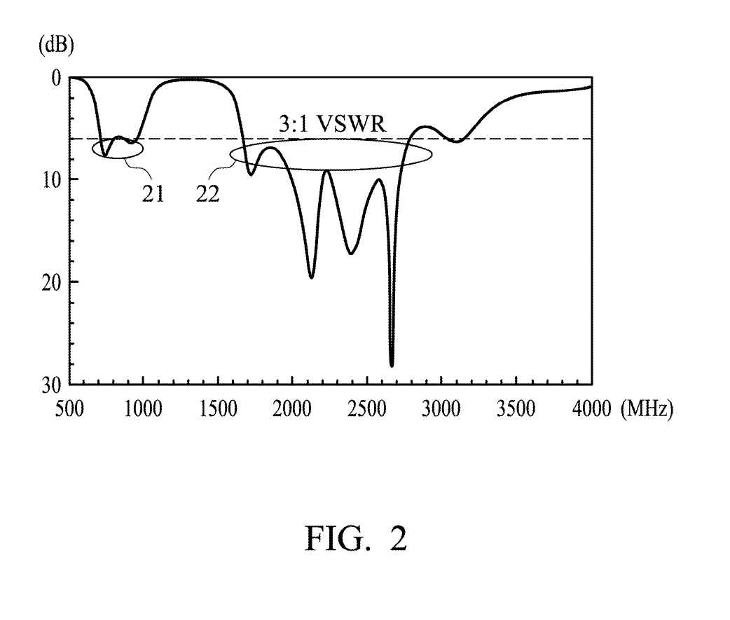

FIG. 2 shows simulated return loss of the antenna 1 of the first embodiment. The substrate 11 of the first embodiment is an FR4 substrate having a width of 35 mm, a length of 15 mm and a thickness of 0.8 mm. The ground element 10 has a length of 100 mm and a width of 60 mm. The radiator 12 is formed on the substrate 11 by printing or etching. The length of the radiator is about 80 mm. The length of the feed conductor 13 is about 25 mm. The capacitor unit 131 is a chip capacitor, and has a capacitance of about 1 pF. The first short-circuiting path 16 has a first path length, the second short-circuiting path 17 has a second path length, and the first and second path lengths are longer than 0.05 times that of a wavelength of a lowest frequency signal (704 MHz) of the first band. The first path length is about 35 mm, and the second path length is about 37 mm. As shown in FIG. 2, under a return loss definition of 6 dB, the first band 21 covers the LTE700/GSM850/900 (704˜960 MHz) bands. The second band 22 covers the GSM1800/1900/UMTS/LTE2300/2500 (171˜2690 MHz) bands. Therefore, the antenna of the embodiment of the invention satisfies LTE/GSM/UMTS (eight bands) transmission requirements. The capacitor unit 131 and the short-circuiting unit 150 increase bandwidths of the antenna of the embodiment of the invention.

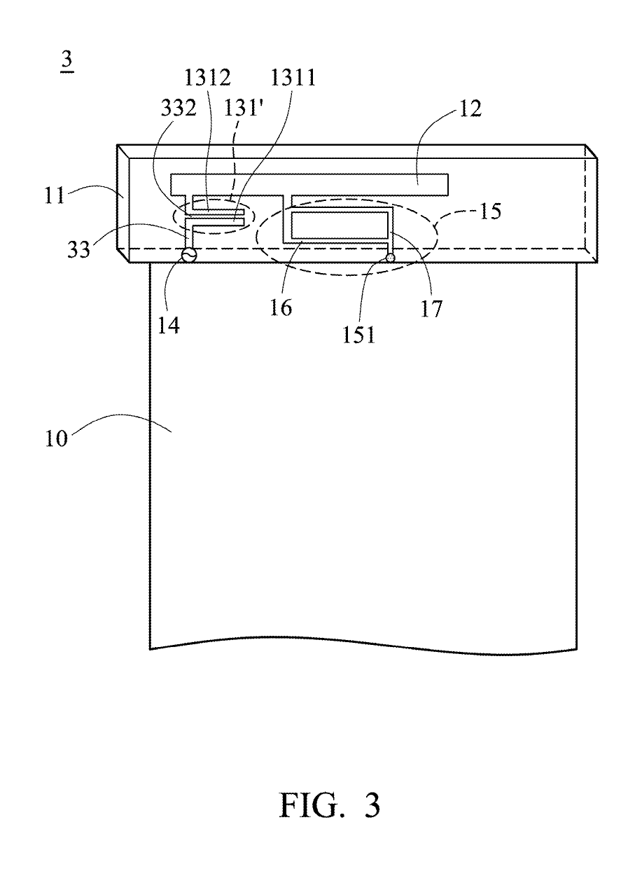

FIG. 3 shows a communication device 3 of a second embodiment of the invention. The communication device 3 of the second embodiment differs from the first embodiment in that the capacitor unit 131 is replaced by the capacitor unit 131′. The capacitor unit 131′ comprises a first capacitance portion 1311 and a second capacitance portion 1312. The first capacitance portion 1311 and the second capacitance portion 1312 are parallel to the radiator 12. An opening portion 332 is formed between the first capacitance portion 1311 and the second capacitance portion 1312. The structure of the communication device 3 of the second embodiment is similar to the structure of the communication device 1 of the first embodiment, and provides similar transmission effects.

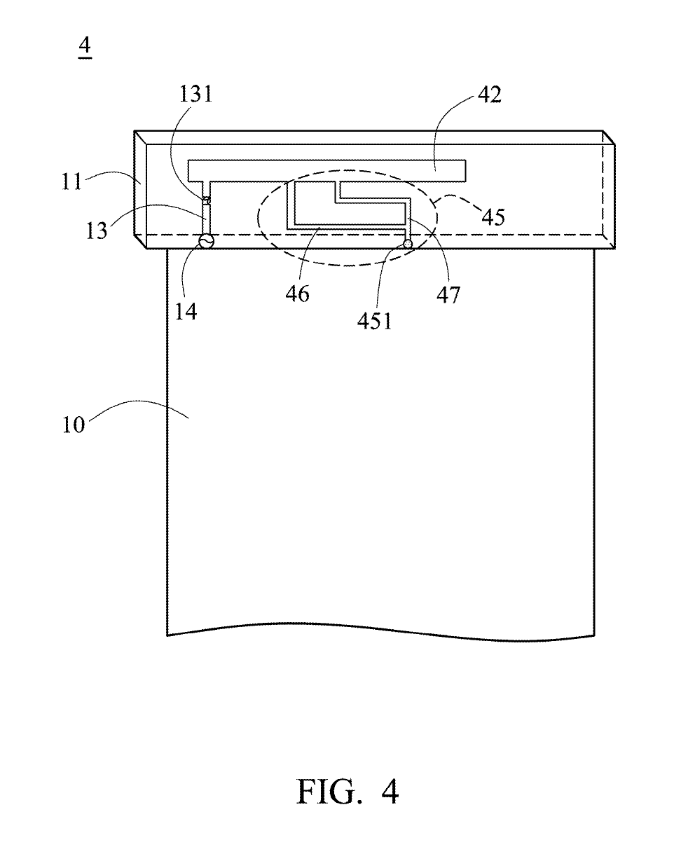

FIG. 4 shows a communication device 4 of a third embodiment of the invention. The communication device 4 of the third embodiment differs from the first embodiment in the short-circuiting unit 45, wherein the first short-circuiting path (first short-circuiting portion) 46 and the second short-circuiting path (second short-circuiting portion) 47 respectively and electrically connect the radiator 12 to the ground element 10. The first short-circuiting path (first short-circuiting portion) 46 and the second short-circuiting path (second short-circuiting portion) 47 are electrically connected to the ground element 10 on the same location (ground point 451). The first short-circuiting portion 46 is connected to the radiator 42 on a first location. The second short-circuiting portion 47 is connected to the radiator 42 on a second location. The first short-circuiting portion 46, the second short-circuiting portion 47 and the radiator 42 define an irregular slot. The structure of the communication device 4 of the third embodiment is similar to the structure of the communication device 1 of the first embodiment, and provides similar transmission effects.

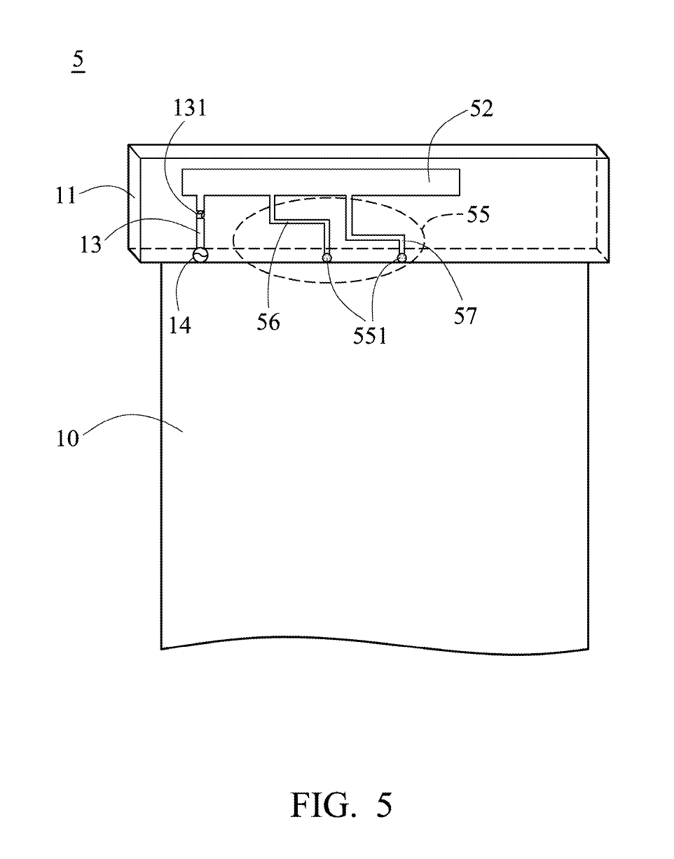

FIG. 5 shows a communication device 5 of a fourth embodiment of the invention. The communication device 5 of the fourth embodiment differs from the first embodiment in the short-circuiting unit 55, wherein the first short-circuiting path (first short-circuiting portion) 56 and the second short-circuiting path (second short-circuiting portion) 57 respectively and electrically connect the radiator 12 to the ground element 10 (ground points 551). The first short-circuiting path (first short-circuiting portion) 56 and the second short-circuiting path (second short-circuiting portion) 57 are respectively and electrically connected to the ground element 10 and the radiator 12 at different locations. The first short-circuiting portion 56 is connected to the radiator 52 at a first location. The second short-circuiting portion 57 is connected to the radiator 52 at a second location. The first short-circuiting portion 56 is connected to the ground element 10 at a third location. The second short-circuiting portion 57 is connected to the ground element 10 at a fourth location. The structure of the communication device 5 of the fourth embodiment is similar to the structure of the communication device 1 of the first embodiment, and provides similar transmission effects.

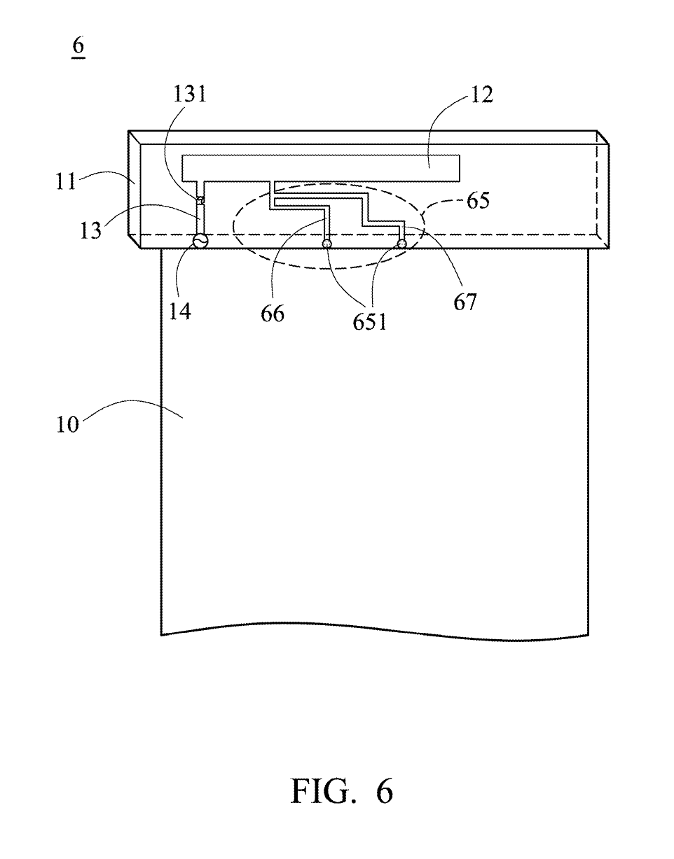

FIG. 6 shows a communication device 6 of a fifth embodiment of the invention. The communication device 6 of the fifth embodiment differs from the first embodiment in the short-circuiting unit 65, wherein the first short-circuiting path (first short-circuiting portion) 66 and the second short-circuiting path (second short-circuiting portion) 67 respectively and electrically connect the radiator 12 to the ground element 10 (ground points 651). The first short-circuiting path (first short-circuiting portion) 66 and the second short-circuiting path (second short-circuiting portion) 67 are electrically connected to the radiator 12 on the same location, and the first short-circuiting path (first short-circuiting portion) 66 and the second short-circuiting path (second short-circuiting portion) 67 are respectively and electrically connected to the ground element 10 at different locations. The structure of the communication device 6 of the structure of the fifth embodiment is similar to the communication device 1 of the first embodiment, and provides similar transmission effects.

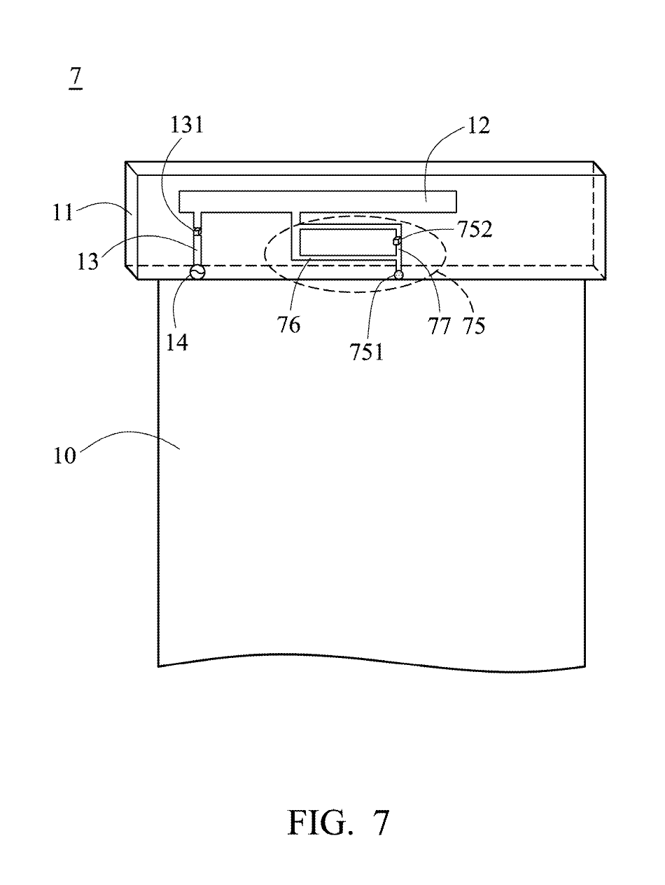

FIG. 7 shows a communication device 7 of a sixth embodiment of the invention. The communication device 7 of the sixth embodiment differs from the first embodiment in the short-circuiting unit 75, wherein an inductor 752 is disposed on the second short-circuiting path 77. The inductor 752 can be a chip inductor. The inductor 752 increases inductance of the communication device, improves impedance matching of the antenna, and increases bandwidth of the antenna. The structure of the communication device 7 of the sixth embodiment is similar to the structure of the communication device 1 of the first embodiment, and provides similar transmission effects.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A communication device, comprising:
a ground element;
a substrate, adjacent to the ground element; and
an antenna, wherein the antenna provides a first band and a second band, and the antenna is disposed on the substrate, the antenna comprises:
a radiator;
a feed conductor, wherein an end of the feed conductor is connected to a signal source, and another end of the feed conductor is electrically connected to the radiator;
a capacitor unit, disposed on the feed conductor; and
a short-circuiting unit, comprising a first short-circuiting path and a second short-circuiting path, wherein the first and a second short-circuiting paths electrically connect the radiator to the ground element, the first short-circuiting path has a first path length, the second short-circuiting path has a second path length, and the first and second path lengths are longer than 0.05 times that of a wavelength of a lowest frequency of the first band.

2. The communication device as claimed in claim 1, wherein the first band covers 704˜960 MHz, and the second band covers 171˜2690 MHz.

3. The communication device as claimed in claim 1, wherein the substrate is a system circuit board of a cell phone.

4. The communication device as claimed in claim 1, wherein the capacitor unit comprises a chip capacitor.

5. The communication device as claimed in claim 1, wherein the capacitor unit is am opening portion formed on the feed conductor.

6. The communication device as claimed in claim 1, further comprising an inductor, disposed on at least one of the short-circuiting paths.

7. The communication device as claimed in claim 6, wherein the inductor is a chip inductor.

8. An antenna, providing a first band and a second band, comprising:
a ground element;
a radiator;
a feed conductor, wherein an end of the feed conductor is connected to a signal source, and another end of the feed conductor is electrically connected to the radiator; and
a short-circuiting unit, comprising a first short-circuiting portion and a second short-circuiting portion, wherein a first short-circuiting path electrically connects the radiator to the ground element via the first short-circuiting portion, a second short-circuiting path electrically connects the radiator to the ground element via the second short-circuiting portion, the first short-circuiting path has a first path length, the second short-circuiting path has a second path length, and the first and second path lengths are longer than 0.05 times that of a wavelength of a lowest frequency of the first band.

9. The antenna as claimed on claim 8, wherein the first short-circuiting portion is substantially L-shaped, and the second short-circuiting portion is substantially L-shaped.

10. The antenna as claimed on claim 8, wherein the first short-circuiting portion and the second short-circuiting portion define a rectangular slot.

11. The antenna as claimed on claim 8, wherein the first short-circuiting portion connects to the radiator at a first location, and the second short-circuiting portion connects to the radiator at a second location.

12. The antenna as claimed on claim 11, wherein the first short-circuiting portion, the second short-circuiting portion and the radiator define an irregular slot.

13. The antenna as claimed on claim 8, wherein the first short-circuiting portion is connected to the ground element at a third location, and the second short-circuiting portion is connected to the ground element at a fourth location.

14. The antenna as claimed on claim 8, wherein the short-circuiting unit further comprises an inductor, disposed on the first short-circuiting portion.
